(19) United States
(12) Patent Application Publication
(10) Pub. No.: US 2014/0192760 A1
(43) Pub. Date: Jul. 10, 2014

(54) Backward Compatibility of PUCCH Formats

(71) Applicants: Kari Pekka Pajukoski, Oulu (FI); Esa Tapani Tiirola, Kempele (FI); Kari Juhani Hooli, Oulu (FI); Timo Erkki Lunttila, Espoo (FI)

(72) Inventors: Kari Pekka Pajukoski, Oulu (FI); Esa Tapani Tiirola, Kempele (FI); Kari Juhani Hooli, Oulu (FI); Timo Erkki Lunttila, Espoo (FI)

(73) Assignee: NOKIA SOLUTIONS AND NETWORKS OY, Espoo (FI)

(21) Appl. No.: 14/238,261

(22) PCT Filed: Aug. 12, 2011
(86) PCT No.: PCT/EP2011/063936

§ 371 Date: Feb. 11, 2014

(51) Int. Cl. H04L 5/00

(52) U.S. Cl. CPC H04L 5/0046; H04L 5/005; H04L 5/0016
USPC 370/329

(57) ABSTRACT

The invention relates to an apparatus including at least one processor and at least one memory including a computer program code, the at least one memory and the computer program code configured to, with the at least one processor, cause the apparatus at least to: configure data symbols for being conveyed by using a first signaling format and a second signaling format, and configure reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

### FIELD

The invention relates to apparatuses, methods, a system, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In the long term evolution advanced (LTE-Advanced), uplink layer 1/layer 2 control signaling takes place on a physical control channel (PUCCH) in the absence of uplink data. Furthermore, a special configuration with simultaneous transmission of PUCCH and Physical Uplink Shared Channel (PUSCH) is also supported in the LTE-Advanced. Therefore, PUCCH transmissions are also possible in the presence of uplink data. The LTE-Advanced PUCCH has, or is going to have, 7 PUCCH formats, namely 1, 1a, 1b, 2, 2a, 2b and 3. The new format 3 is designed to convey acknowledgement/no-acknowledgement (ACK/NACK) bits.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: configure data symbols for being conveyed by using a first signaling format and a second signaling format, and configure reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

According to yet another aspect of the present invention, there is provided an apparatus comprising: at least one processor and at least one memory including a computer program code, the at least one memory and the computer program code configured to, with the at least one processor, cause the apparatus at least to: obtain signaling configuration of a first signaling format, wherein the first signaling format is an extended payload format and the second signaling format is a legacy format, and a bandwidth of the extended payload format is larger than that of the legacy format, and the first signaling format and the second signaling format utilize at least partly same frequency and code domain resources, and configure a signaling transmission according to the signaling configuration of the first signaling format.

According to yet another aspect of the present invention, there is provided a method comprising: configuring data symbols for being conveyed by using a first signaling format and a second signaling format, and configuring reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

According to yet another aspect of the present invention, there is provided a method comprising: obtaining signaling configuration of a first signaling format, wherein the first signaling format is an extended payload format and the second signaling format is a legacy format, and a bandwidth of the extended payload format is larger than that of the legacy format, and the first signaling format and the second signaling format utilize at least partly same frequency and code domain resources, and configuring a signaling transmission according to the signaling configuration of the first signaling format.

According to yet another aspect of the present invention, there is provided an apparatus comprising: means for configuring data symbols for being conveyed by using a first signaling format and a second signaling format, and means for configuring reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

According to yet another aspect of the present invention, there is provided an apparatus comprising: means for obtaining signaling configuration of a first signaling format, wherein the first signaling format is an extended payload format and the second signaling format is a legacy format, and a bandwidth of the extended payload format is larger than that of the legacy format, and the first signaling format and the second signaling format utilize at least partly same frequency and code domain resources, and means for configuring a signaling transmission according to the signaling configuration of the first signaling format.

According to yet another aspect of the present invention, there is provided a computer program embodied on a computer-readable storage medium, the computer program comprising program code for controlling a process to execute a process, the process comprising: configuring data symbols for being conveyed by using a first signaling format and a second signaling format, and configuring reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

According to yet another aspect of the present invention, there is provided a computer program embodied on a computer-readable storage medium, the computer program comprising program code for controlling a process to execute a process, the process comprising: obtaining signaling configuration of a first signaling format, wherein the first signaling format is an extended payload format and the second signaling format is a legacy format, and a bandwidth of the extended payload format is larger than that of the legacy format, and the first signaling format and the second signaling format utilize at least partly same frequency and code domain resources, and configuring a signaling transmission according to the signaling configuration of the first signaling format.

According to yet another aspect of the present invention, there is provided an apparatus comprising: at least one processor and at least one memory including a computer program code, the at least one memory and the computer program code configured to, with the at least one processor, cause the apparatus at least to: generate a first signalling unit for conveying uplink control information on a physical uplink control channel, the first signalling unit comprising at least two data parts of a second signalling unit and at least one reference signal part.

According to yet another aspect of the present invention, there is provided a computer program embodied on a computer-readable storage medium, the computer program comprising program code for controlling a process to execute a process, the process comprising: generating a first signalling unit for conveying uplink control information on a physical uplink control channel, the first signalling unit comprising at least two data parts of a second signalling unit and at least one reference signal part.

### LIST OF DRAWINGS

Some embodiments of the present invention are described below, by way of example only, with reference to the accompanying drawings, in which

FIG. 1 illustrates an example of a system;

FIG. 2 shows an example of format structure;

FIG. 3 is a flow chart;

FIG. 4 is another flow chart;

FIG. 5 illustrates examples of apparatuses;

FIG. 6 illustrates other examples of apparatuses, and

FIG. 7 illustrates yet other examples of apparatuses.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately.

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the (e)NodeB.

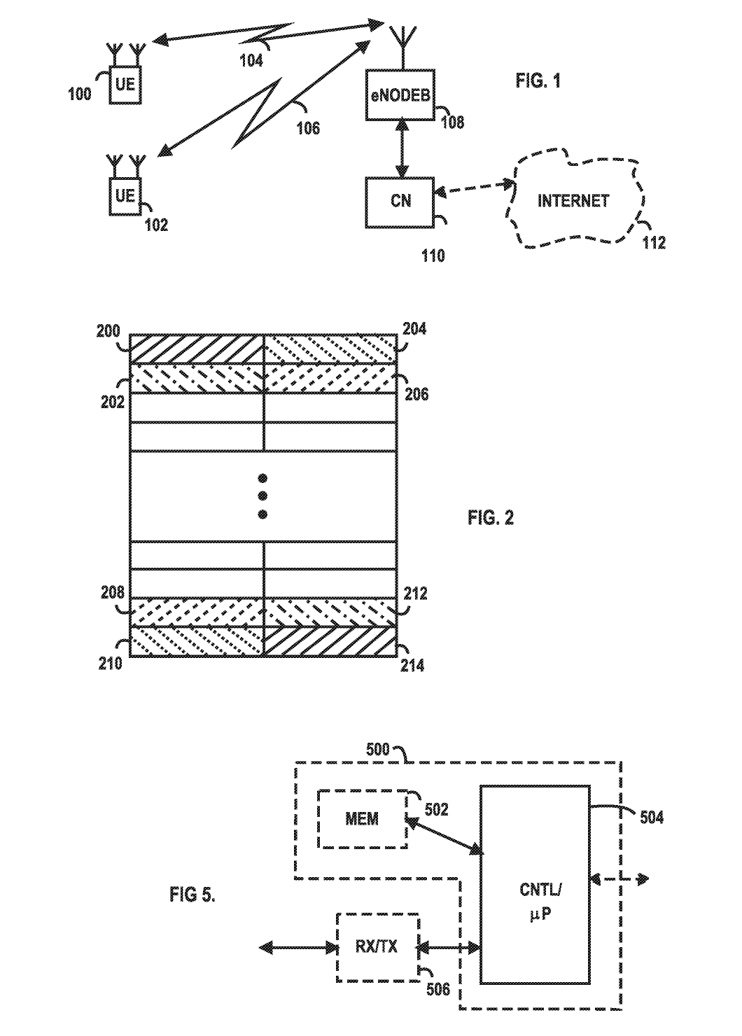

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

FIG. 1 shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeB 108 of FIG. 1 may provide any kind of these cells. A cellular radio system may be implemented as a multilayer network including several kinds of cells. Typically, in multilayer networks, one node B provides one kind of a cell or cells, and thus a plurality of node Bs are required to provide such a network structure.

A hybrid-automatic repeat request (HARQ) is a feature designed to enhance the performance of packet data transmission. Usually, the HARQ controls and initiates packet retransmission on layer 1 (physical layer), to reduce retransmission delay caused by higher layer transmission. In the case of a link error, caused for instance by interference, a receiving entity may request retransmission of corrupted data packets. HARQ is a “stop and wait” protocol of a nature: a subsequent transmission may take place only after receiving an ACK/NACK from a receiving entity.

LTE-Advanced (LTE-A) system release 10 introduces a new PUCCH format called PUCCH format 3. The PUCCH format 3 is a standardized signalling scheme for HARQ-ACK/NACK (ACK/NACK=acknowledgement, no-acknowledgement) on PUCCH for user devices that support more than 4 downlink ACK/NACK bits with carrier aggregation. Although, in the LTE release 10, the usage of PUCCH format 3 is limited to HARQ ACK/NACK feedback, it is basically also usable in other applications, such as coordinated multi-point transmission/reception (CoMP) channel state information (CSI) feedback and enhanced multiple-input-multiple-output (MIMO) CSI feedback as well as low rate services like voice over Internet (VoiP) and/or machine type communications. Thus a need for a backward compatible payload enhancement method for PUCCH format 3 exists.

FIG. 2 depicts an example of the structure of PUCCH format 3, when bandwidth is one physical resource block and frequency hopping is used to obtain frequency diversity gain. The FIG. 2 shows 4 frequency hopping PUCCH physical resource blocks 200-206 which each also represents one time slot. As the FIG. 2 illustrates, the frequency hopping is slot-based (physical resource blocks (and time slots) 208-214. In PUCCH format 3, data signals from different users within a single cell are separated by different block level spreading codes providing support to up to 5 simultaneous users per each physical resource block (PRB) and subframe. Reference signals are separated by different cyclic sifts of the same reference signal sequence.

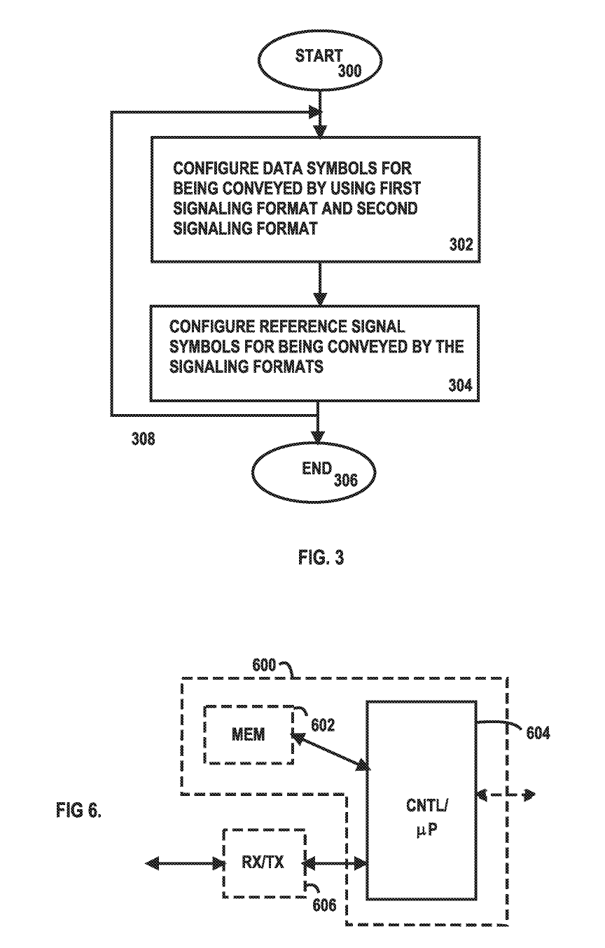

The bandwidth of PUCCH format 3 may be extended to provide increased payload sizes. An extended bandwidth may be larger than one physical resource block. Hence the supported data payload may also be larger than that of the LTE release 10 PUCCH format 3. Orthogonality between extended format and legacy format (meaning an earlier or “traditional” format, such as PUCCH format 3 in the LTE release 10) enables the existence of legacy users and users using the extended format on the same frequency and/or time resources (PRBs). Thus the extended format may be used without introducing allocation restrictions for legacy users, when orthogonality is provided. Additionally, reference signals of the extended format and the legacy format may be made orthogonal to each other by orthogonal cover codes and/or cyclic shifts. Flexible allocation of “normal” PUCCH format 3 resources and PUCCH format 3 resources with an extended payload by using one common resource pool is needed in order to avoid unnecessary capacity loss due to multiple separate resource pools. Some embodiments suitable for obtaining payload extension for uplink control information on PUCCH are disclosed in further details in relation to FIG. 3.

The embodiment of FIG. 3 is usually related to a node, host, server or other corresponding entity. The embodiment begins in block 300.

In block 302, data symbols are configured for being conveyed by using a first signaling format and a second signaling format,

A first signaling format is an extended payload format or an extended format and a second signaling format is a legacy format that is to say a non-extended (traditional or normal) format. The bandwidth of the extended payload format is larger than that of the legacy format, and the first signaling format and the second signaling format utilize at least partly same frequency and code domain resources.

An extended payload format may be characterized to utilize more than one (data and/or reference signal) resources of a non-extended format.

Data symbols may be orthogonalized by means of orthogonal block spreading code allocation between the formats. In this case the orthogonality is obtained between data symbols using different formats. In practice, the orthogonality is not usually perfect (inherent limitations of code division multiple access may cause deviation from perfect orthogonality), but good enough to provide protection against mutual interference.

In block 304, reference signal symbols are configured for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

Reference signal part may be orthogonalized by multiplying reference signal (RS) symbols of an extended format with orthogonal cover code [1 −1]. In this approach the length of the RS sequence corresponding to the extended format may be defined according to a current total bandwidth of data allocation. The cover code [1 1] (that is to say a non-orthogonal cover code) used in the legacy format provides orthgonality between the extended format and the legacy format. Alternatively, an RS symbol sequence of the extended format may be structured from RS sequences used in the legacy format by concatenating them, for example. In this case orthogonality may be provided by allocating orthogonal cyclic shifts for the legacy and extended formats.

In one embodiment, an extended format 3 is transmitted without frequency hopping between slots in such a manner that both separated clusters (corresponding to physical resource blocks (PRBs) used for frequency hopping in legacy format 3) are transmitted simultaneously. In this case both clusters typically contain different data symbols. Orthogonalizating may be carried out as described above.

Orthogonal cover codes enable orthogonality between the extended format and legacy format. Thus legacy users and users using the extended format may co-exist on at least partially same frequency and/or time resources (PRBs). Embodiments also provide backwards compatibility, hence the extended format may be used without introducing allocation restrictions for legacy users. Furthermore, the payload sizes of PUCCH format 3 are flexibly scalable by assigning desired number of resources (PRBs). This provides better support for cases, wherein requirements for uplink control signaling are increased, such as reporting channel state information (CSI) for carrier aggregation, downlink multiple input-multiple output (MIMO) and/or coordinated multi-point transmission (CoMP).

As background information for better understanding of possible implementation options of embodiments, LTE release 10 resource allocation for transmission of PUCCH format 3 signaling is now disclosed.

Resources are identified by a resource index n_{PUCCH}^{(3,\tilde{p})} and physical resource blocks to be used for PUCCH transmission in frequency slot nₛ are given by:

$${N}_{sc}^{RB} \\ {n}_{PRB} = \{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1 ,\end{matrix} \qquad ( 1 )$$

wherein
N_{RB}^{UL} denotes an uplink bandwidth configuration expressed in multiples of N_{sc}^{RB} which denotes a resource block size in the frequency domain expressed as a number of subcarriers,
mod 2 denotes modulo 2 operation, and
m denotes a variable which for PUCCH format 3 is given as:

m=└n_{PUCCH}^{(3,\tilde{p})}/N_{SF,0}^{PUCCH}┘, (2)

wherein n_{PUCCH}^{(3,\tilde{p})} denotes a resource index, and
N_{SF,0}^{PUCCH} denotes a length of an orthogonal cover code of a first frequency slot.

Orthogonal cover codes for the first and a second frequency slot, denoted as n_{oc,0}^{(\tilde{p})} and n_{oc,1}^{(\tilde{p}) are derived from a PUCCH format resource index according to:}

$${n}_{oc , 0}^{( \tilde{p} )} = {n}_{PUCCH}^{( 3 , \tilde{p} )} mod {N}_{SF , 1}^{PUCCH} \\ {n}_{oc , 1}^{( \tilde{p} )} = \{ \begin{matrix}( 3 {n}_{oc , 0}^{( \tilde{p} )} ) mod {N}_{SF , 1}^{PUCCH} & if {N}_{SF , 1}^{PUCCH} = 5 \\ {n}_{oc , 0}^{( \tilde{p} )} mod {N}_{SF , 1}^{PUCCH} & otherwise ,\end{matrix} \qquad ( 3 )$$

wherein
n_{PUCCH}^{(3,\tilde{p})} denotes a resource index,
N_{SF,1}^{PUCCH} denotes a length of an orthogonal cover code of a second frequency slot, and
mod denotes modulo operation.

Reference signal resources for PUCCH format 3 signaling are defined by means of a cyclic shift α_{\tilde{p}}(nₛ,l) and is given by:

α_{\tilde{p}}(nₛ,l)=2π·n_{cs}^{(\tilde{p})}(nₛ,l)/N_{sc}^{RB}

n_{cs}^{(\tilde{p})}(nₛ,l)=(n_{cs}^{cell}(nₛ,l)+n_{\tilde{p}}′(nₛ))mod N_{sc}^{RB} (4)

wherein
(nₛ,l) denotes a slot index and a symbol within a subframe, respectively,
N_{sc}^{RB} denotes a resource block size in the frequency domain expressed as a number of subcarriers,
n_{cs}^{cell} denotes a cell-specific cyclic shift,
n_{\tilde{p}}′(nₛ) denotes resource indices within two resource blocks in two slots of a subframe to which PUCCH signaling is mapped and they are given by Table 1 below, and
mod denotes modulo operation.

Table 1 shows relations between n_{oc,0}^{(\tilde{p})} and n_{oc,1}^{(\tilde{p})} for PUCCH format 3. In the Table 1, n_{oc,0}^{(\tilde{p})} and n_{oc,1}^{(\tilde{p})} are orthogonal cover codes (OCC) for a first and second slots in a subframe. Additionally, N/A denotes “not available”.

TABLE 1

n_{\tilde{p}}(nₛ)

| n_{oc,0}^{(\tilde{p})} | N_{SF,1} = 5 | N_{SF,1} = 4 |
|---|---|---|
| 0 | 0 | 0 |
| 1 | 3 | 3 |
| 2 | 6 | 6 |
| 3 | 8 | 9 |
| 4 | 10 | N/A |

In the following, some embodiments of enhanced signaling for supporting extended format are disclosed.

In one option, multiple n_{PUCCH}^{(3,\tilde{p})} s (resource indexes) are signaled for separately forming a resource corresponding to extended PUCCH format 3. Orthogonal cover codes (OCC), reference signal (RS) resources and PRB allocation may be derived separately for each resource index. This provides a multi-cluster transmission or even multi-signal transmission on same resources, thus no need to transmit separate reference signals for all data signals or signal parts exists. A multi-signal transmission may take place when n_{PUCCH}^{(3,\tilde{p})} falls into same PRB resources.

In another option, n_{PUCCH}^{(3,\tilde{p})} is signaled only once. PRB, OCC and/or RS allocation are signaled separately or derived implicitly from n_{PUCCH}^{(3,\tilde{p})}. Single n_{PUCCH}^{(3,\tilde{p})} may define a starting PRB of the extended PUCCH format 3. Bandwidth allocation for the extended PUCCH format 3 may be signaled separately as well.

Additionally, bandwidth allocation may also be derived implicitly by using suitable parameters, such as the number of bits. The allocation of orthogonal cover codes for a data signal part may be according to n_{PUCCH}^{(3,\tilde{p})}. It is also possible to signal orthogonal cover codes separately for different PRBs. Reference signal bandwidth may be defined based on an allocated bandwidth. The cyclic shift of a reference signal may be derived from allocation of the orthogonal cover code as also in LTE release 10. Orthogonal cover code [1, −1] may be applied between reference signals within one slot, if allocated bandwidth is more than 1 PRB. The orthogonal cover code may be signaled explicitly as well.

Additionally, if a slot-based frequency hopping is not used, orthogonal cover code [1, −1] may be applied between two reference signals of a subframe (when an extended cyclic prefix is used). Alternatively, the length of an orthogonal cover code may be increased from two to four (when a normal cyclic prefix is used).

Yet another option is to combine the options listed above.

It should be appreciated that PUCCH format 3 configuring may be carried out within one physical resource block and time slot.

The embodiment ends in block 306. The embodiment is repeatable in many ways. One example is shown by arrow 308 in FIG. 3.

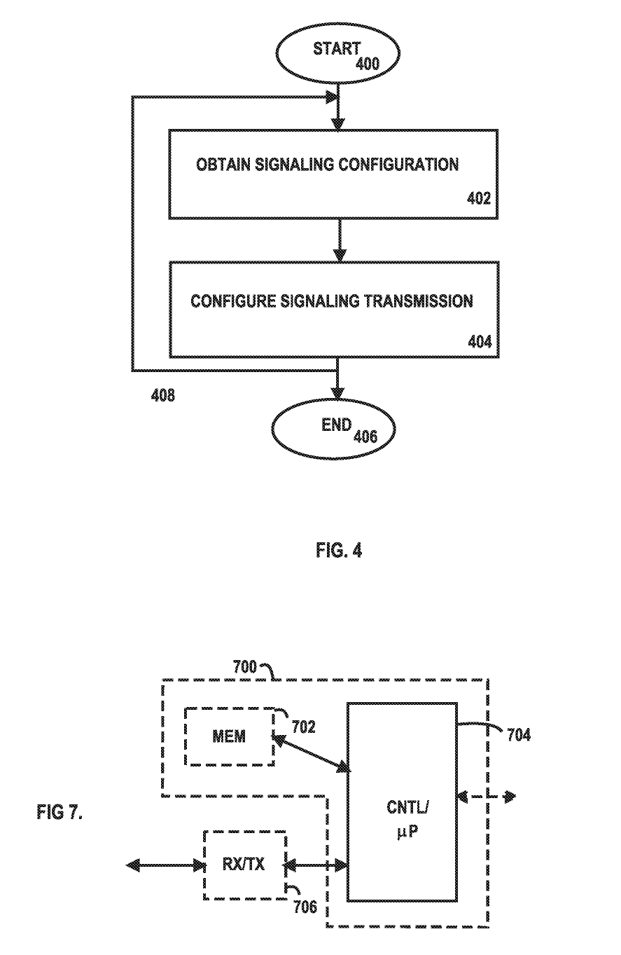

Some further embodiments suitable for payload extension for uplink control information on PUCCH are disclosed in further details in relation to FIG. 4.

The embodiment of FIG. 4 is usually related to a user device, relay node, home node, web stick or other corresponding entity. The embodiment begins in block 400.

In block 402, signaling configuration of a first signaling format is obtained, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

Signaling formats are disclosed in further detail above in relation to FIGS. 2 and 3. A frequency domain resource may be a carrier having a certain bandwidth and center frequency, and a code domain resource may be any code from a currently available code pool. Obtaining of the signaling configuration may be carried out by receiving it from a network node.

In block 404, a signaling transmission is configured according to the signaling configuration of the first signaling format.

Transmission configuration may be carried out by any suitable means and procedures according to currently used standards and applications.

The embodiment ends in block 406. The embodiment is repeatable in many ways. One example is shown by arrow 408 in FIG. 4.

The steps/points, signaling messages and related functions described above in FIGS. 3 and 4 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, transmitting and/or receiving may herein mean preparing a data conveyance, transmission and/or reception, preparing a message to be conveyed, transmitted and/or received, or physical transmission and/or reception itself, etc. on a case by case basis.

An embodiment provides an apparatus which may be any server, host, node or any other suitable apparatus capable to carry out processes described above in relation to FIG. 3.

FIG. 5 illustrates a simplified block diagram of an apparatus according to an embodiment.

As an example of an apparatus according to an embodiment, it is shown an apparatus 500, such as a server, host or node, including facilities in a control unit 504 (including one or more processors, for example) to carry out functions of embodiments according to FIG. 3.

In FIG. 5, block 506 includes parts/units/modules need for reception and transmission, usually called a radio front end, RF-parts, radio parts, etc. This block is optional.

Another example of an apparatus 500 may include at least one processor 504 and at least one memory 502 including a computer program code, the at least one memory and the computer program code configured to, with the at least one processor, cause the apparatus at least to: configure data symbols for being conveyed by using a first signaling format and a second signaling format, and configure reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

Yet another example of an apparatus comprises means 504 for configuring data symbols for being conveyed by using a first signaling format and a second signaling format, and means 504 for configuring reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

Yet another example of an apparatus comprises a first configuring unit configured to configure data symbols for being conveyed by using a first signaling format and a second signaling format, and a second configuring unit configured to configure reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

Another embodiment provides an apparatus which may be any user device, home node, web stick or any other suitable apparatus capable to carry out processes described above in relation to FIG. 4.

FIG. 6 illustrates a simplified block diagram of an apparatus according to an embodiment.

As an example of an apparatus according to an embodiment, it is shown an apparatus 600, such as a user device, relay node or web stick, including facilities in a control unit 604 (including one or more processors, for example) to carry out functions of embodiments according to FIG. 4.

In FIG. 6, block 606 includes parts/units/modules need for reception and transmission, usually called a radio front end, RF-parts, radio parts, etc. This block is optional. This block may be used for obtaining a signalling configuration.

Another example of an apparatus 600 may include at least one processor 604 and at least one memory 602 including a computer program code, the at least one memory and the computer program code configured to, with the at least one processor, cause the apparatus at least to: obtain signaling configuration for a first signaling format, wherein the first signaling format is an extended payload format and the second signaling format is a legacy format, and a bandwidth of the extended payload format is larger than that of the legacy format, and the first signaling format and the second signaling format utilize at least partly same frequency and code domain resources, and configure a signaling transmission according to the first signaling format.

Yet another example of an apparatus comprises means 604 for obtaining signaling configuration for a first signaling format, wherein the first signaling format is an extended payload format and the second signaling format is a legacy format, and a bandwidth of the extended payload format is larger than that of the legacy format, and the first signaling format and the second signaling format utilize at least partly same frequency and code domain resources, and means 604 for configuring a signaling transmission according to the first signaling format.

Yet another example of an apparatus comprises an obtainer configured to obtain signaling configuration for a first signaling format, wherein the first signaling format is an extended payload format and the second signaling format is a legacy format, and a bandwidth of the extended payload format is larger than that of the legacy format, and the first signaling format and the second signaling format utilize at least partly same frequency and code domain resources, and a configuring unit configured to configure a signaling transmission according to the first signaling format.

Another example of an apparatus disclosed herein by means of FIG. 7, is suitable for generating a signalling unit for conveying information on a physical uplink control channel (PUCCH). FIG. 7 illustrates a simplified block diagram of an apparatus according to an embodiment.

As an example of an apparatus according to an embodiment, it is shown an apparatus 700, such as a user device, relay node, server, node, host or web stick, including facilities in a control unit 704 (including one or more processors, for example) to carry out the generating of a signalling unit for conveying information on a physical uplink control channel.

In FIG. 7, block 706 includes parts/units/modules need for reception and transmission, usually called a radio front end, RF-parts, radio parts, etc. This block is optional.

Another example of an apparatus 700 may include at least one processor 704 and at least one memory 702 including a computer program code, the at least one memory and the computer program code configured to, with the at least one processor, cause the apparatus at least to: generate a first signalling unit for conveying uplink control information on a physical uplink control channel, the first signalling unit comprising at least two data parts of a second signalling unit and at least one reference signal part.

Yet another example of an apparatus comprises means 704 for generating a first signalling unit for conveying uplink control information on a physical uplink control channel, the first signalling unit comprising at least two data parts of a second signalling unit and at least one reference signal part.

Yet another example of an apparatus comprises a generator configured to generate a first signalling unit for conveying uplink control information on a physical uplink control channel, the first signalling unit comprising at least two data parts of a second signalling unit and at least one reference signal part.

The first signalling unit may be a signalling transmission or conveyance unit, signalling transmission or corresponding entity or action which takes place or is configured by using the extended signalling format disclosed above in relation to FIG. 3. The second signalling unit may be a signalling transmission or conveyance unit, signalling transmission or corresponding entity or action which takes place or is configured by using the legacy format disclosed above in relation to FIG. 3.

In one embodiment, the at least two data parts may comprise orthogonal cover codes.

In another embodiment, the at least one reference signal part may comprise at least one reference signal according to data-allocation and at least one orthogonal cover code, a reference signal stack and/or one reference signal, if orthogonal cover codes are in a same physical resource block.

It should be understood that the apparatuses may include or be coupled to other units or modules etc, such as radio parts or radio heads, used in or for transmission and/or reception. This is depicted in FIGS. 5, 6 and 7 as optional blocks 506, 606 or 706.

Although the apparatuses have been depicted as one entity in FIGS. 5, 6 and 7, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, may be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node or user device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers. The computer readable medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
configure data symbols for being conveyed by using a first signaling format and a second signaling format, and
configure reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

2. An apparatus comprising:
at least one processor and at least one memory including a computer program code, the at least one memory and the computer program code configured to, with the at least one processor, cause the apparatus at least to:
obtain signaling configuration of a first signaling format, wherein the first signaling format is an extended payload format and the second signaling format is a legacy format, and a bandwidth of the extended payload format is larger than that of the legacy format, and the first signaling format and the second signaling format utilize at least partly same frequency and code domain resources, and
configure a signaling transmission according to the signaling configuration of the first signaling format.

3. The apparatus of claim 1, wherein the reference signal symbols are orthogonalized by multiplying reference signal symbols of the first signaling format with orthogonal cover code [1 −1].

4. The apparatus claim 1, wherein the reference signal symbols of the first signaling format are concatenated and the orthogonalization is carried out by allocating orthogonal cyclic shifts for the first signaling format and the second signaling format.

5. The apparatus claim 1, wherein the first signalling format is transmitted without frequency hopping between slots in such a manner that both physical resource blocks used for frequency hopping are transmitted simultaneously.

6. The apparatus of claim 1, wherein a resource index with regard to the first signaling format is signaled separately for each physical resource block, and wherein orthogonal cover codes and reference signal resources are derived separately for the physical resource blocks.

7. The apparatus of claim 1, wherein the first signalling format is transmitted without frequency hopping between slots in such a manner that both physical resource blocks used for frequency hopping are transmitted simultaneously and wherein orthogonal cover code [1, −1] is applied between two reference signals of one subframe or length of the orthogonal cover code is increased from two to four.

8. The apparatus claim 1, the apparatus comprising a user device, relay node, web stick, server, host or node.

9. (canceled)

10. A method comprising:
configuring data symbols for being conveyed by using a first signaling format and a second signaling format, and
configuring reference signal symbols for being conveyed by using the first signaling format and the second signaling format for obtaining payload extension for uplink control information on a physical uplink control channel, wherein the first signaling format is an extended payload format and the second signaling format is a legacy format, and a bandwidth of the extended payload format is larger than that of the legacy format, and the first signaling format and the second signaling format utilize at least partly same frequency and code domain resources.

11. A method comprising:
obtaining signaling configuration of a first signaling format, wherein the first signaling format is an extended payload format and the second signaling format is a legacy format, and a bandwidth of the extended payload format is larger than that of the legacy format, and the first signaling format and the second signaling format utilize at least partly same frequency and code domain resources, and
configuring a signaling transmission according to the signaling configuration of the first signaling format.

12. The method of claim 10, wherein the reference signal symbols are orthogonalized by multiplying reference signal symbols of the first signaling format with orthogonal cover code [1 −1].

13. The method of claim 10, further comprising:
concatenating the reference signal symbols of the first signaling format, and
carrying out the orthogonalizing by allocating orthogonal cyclic shifts for the first signaling format and the second signaling format.

14. The method of claim 10, further comprising:
transmitting the first signalling format without frequency hopping between slots in such a manner that both physical resource blocks used for frequency hopping are transmitted simultaneously.

15. The method of claim 10, further comprising:
separately signaling a resource index with regard to the first signaling format for each physical resource block, and
deriving orthogonal cover codes and reference signal resources separately for the physical resource blocks.

16. The method of claim 10, further comprising:
separately signaling a resource index with regard to the first signaling format for each physical resource block;
deriving orthogonal cover codes and reference signal resources separately for the physical resource blocks, and
applying the orthogonal cover code [1, −1] between two reference signals of one subframe, or increasing a length of the orthogonal cover code from two to four.

17.-34. (canceled)
